(19) United States
(12) Patent Application Publication
(10) Pub. No.: US 2005/0031091 A1
(43) Pub. Date: Feb. 10, 2005

(54) Panel SaverTM CPE detection apparatus and method

(76) Inventor: Harvey Alexander Elliot, Ojai, CA (US)

Correspondence Address: Robert Platt Bell, 8033 Washington Road, Alexandria, VA, 22308, US

(21) Appl. No.: 10/840,280

(22) Filed: May 7, 2004

Related U.S. Application Data
(63) Continuation-in-part of application No. 10/462,708, filed on Jun. 17, 2003.
(60) Provisional application No. 60/389,960, filed on Jun. 20, 2002.

(51) Int. Cl. H04M 11/04

(52) U.S. Cl. 379/37; 379/45

(57) ABSTRACT

A current detection circuit is connected in series with the TIP2 and RING2 lines of the alarm panel to detect when consumer provided equipment (CPE) is off-hook. When the alarm system goes off-hook, no current draw will be detected. The apparatus can thus distinguish the difference when a consumer device (phone, fax, modem) goes off-hook and when the alarm panel goes off-hook, and thus determine when the alarm panel is trying to dial out.

### CROSS-REFERENCE TO RELATED APPLICATIONS

The present application is a Continuation-In-Part of U.S. patent application Ser. No. 10/462,708, filed on Jun. 17, 2003, and incorporated herein by reference in its entirety. That Patent Application in turn claims priority from Provisional U.S. Patent Application Ser. No. 60/389,960 filed on Jun. 20, 2002, also incorporated herein by reference in its entirety.

### FIELD OF THE INVENTION

The present invention relates to alarm systems. In particular, the present invention is directed toward an apparatus and method for monitoring a telephone line and detecting when an alarm system is attempting to dial out. This invention has particular application for use in an apparatus and system for redirecting alarm calls.

### BACKGROUND OF THE INVENTION

Alarm systems are well known in the art for use with homes or businesses. In a typical business or home alarm, a number of sensors may be provided to detect various conditions. Examples of these sensors include door and window sensors, motion sensors, glass break detectors, heat and fire sensors, flood sensors and sprinkler system pressure sensors. When one of these sensors is activated (e.g., burglary or fire occurs, or false alarm) the sensor communicates with a control panel.

The control panel, typically microprocessor controlled, may receive sensor signals, as well as signals from sensors indicating sensor tampering, battery status, and sensor maintenance status. From a predetermined program, the microprocessor may determine whether an alarm should be sounded (e.g., Police or Fire), sound the appropriate alarm, and telephone an alarm company to indicate an alarm condition exists.

Most radio frequency (RF) wireless security systems available today, such as those manufactured by Alarm Manufacturing Device Co. (ADEMCO) 165 Eileen Way, Syosset, N.Y. 11791, employ a multiplicity of transmitters in communication with a central receiver control unit. The information transmitted typically describes the state of various transducers or sensors associated with each transmitter, such as smoke, motion, breaking glass, shock and vibration detectors, door, window and floor mat switches, and the like. These transmitters are designed to be inexpensive to manufacture.

Most of these alarm systems are manufactured by a few main alarm system manufacturers. As such, such standardized equipment is relatively inexpensive to purchase, maintain, repair and replace. However, some major alarm companies which do large volumes of nationwide business have purchased from these major alarm manufacturers, specialized or “proprietary” versions of these standardized alarm systems.

The reasons for modifying the standardized alarm system are many. For some large alarm companies, the alarm equipment is leased to the consumer, and the alarm company does not want the equipment to be readily used by others. In other instances, where the alarm equipment is sold to the consumer, the use of a “proprietary” version of the alarm system makes it more difficult for the consumer to switch to different alarm monitoring companies.

It should be noted that the term “proprietary” as used here (and as is used in the alarm industry) does not necessarily imply that these modified alarm systems employ any protected intellectual property (e.g., Patents, Copyrights, trade secrets) above and beyond the underlying standard alarm system technology. Rather, the changes to the system to make it “proprietary” relate more to changing the coding used to report alarms, pre-programming of telephone numbers and the like (e.g. 1-800 number to report alarms) and coding used to communicate from the alarm monitoring company to the alarm system (for maintenance and the like).

By slightly altering this coding (e.g., via PROM chip within the control panel or the like) the alarm company has made it much more difficult for a third party alarm monitoring company to monitor the alarm system. Extensive re-programming may be required by a skilled service technician at the site to reprogram the alarm dial-up numbers and alarm codes to conform to the third party alarm monitoring companies numbers and codes.

Such reprogramming may require temporary installation of a programming control panel, as typical consumer control panels may not provide sufficient feedback for programming proposes (e.g., limited display capabilities). Moreover, such programming requires the skills and experience of a knowledgeable technician in the field. Such knowledgeable technicians are hard to come by, expensive to train, and difficult to retain. Improper programming can result in all alarm system settings being lost and even the system being locked out, requiring extensive manual re-programming and “learning” by activating each sensor in the system.

Moreover, the hourly rate of a skilled alarm technician is higher than a standard alarm technician. Thus, if a third party alarm company wants to “convert” a customer (with proprietary equipment) from a major alarm company, considerable cost must be incurred to re-program the consumer's alarm system. As a third party alarm monitoring company may be competing on price, this re-programming adds cost to the alarm company's bottom line, making them less competitive, which is exactly the reason the major alarm companies use proprietary systems in the first place—to keep customers captive.

Moreover, in some instances, it may not be possible at all to reprogram the alarm system. The alarm system may be so modified (or indeed, custom made for the major alarm company) that it cannot be reprogrammed for use with any other alarm company. In such a scenario, the third party alarm company would have to install a whole new alarm system (or at least a new control panel), which may not be cost-effective.

Without competition in the marketplace, the consumer may find themselves in a difficult situation—stuck with an expensive alarm system that would be prohibitive in cost to replace, and stuck with an alarm monitoring company that may be providing inadequate service at whatever prices it chooses to dictate.

A solution which would allow for greater consumer choice would improve competition in the marketplace. Such a solution should be easy to install, inexpensive, and not require the services of a skilled alarm technician.

It can be appreciated that digital data communicators have been in use for years. However, a digital translator for an alarm system is not known to exist. The main problem with digital communicators is that they require a considerable amount of time to be installed by a skilled technician. Another problem is that a digital alarm communicator system manufactured in the past may not have the ability to accept new dialing patterns or other changes as required by the communications industry (e.g., move to 10-digit phone numbers or the like).

Another problem with a digital alarm communicator system manufactured in the past may be the requirement that communication only occur with a digital alarm communicator receiver that was manufactured by a specific company. Thus, for example, if an alarm monitoring company wishes to monitor a number of different customers who use different brands of equipment, the alarm company may need to purchase separate central station monitoring equipment for each brand of alarm monitored.

This central station monitoring equipment (i.e., equipment at the alarm company monitoring headquarters) can be fairly expensive to purchase. Moreover, the use of different brands of monitoring equipment requires having the skills to repair and maintain the different brands of central station monitoring equipment. Alarm monitoring personnel may need to be trained on different types of equipment and monitor different equipment simultaneously. In addition, since each system may be separate, it may be difficult to provide a single display or interface to the alarm monitor personnel or to record or log alarms in a single central system.

Another problem with a digital alarm communicator system is that some manufacturers of digital alarm communicator systems have ceased supporting the dialers or other hardware or have gone out of business—consequently leaving the consumer with no choice but to replace installed equipment with new equipment. Another problem with existing products is that the original installing company may have gone out of business, depriving the new provider of essential information necessary to reprogram the existing system.

Digital data translators per se, are known in the art. For example, Barclay, U.S. Pat. No. 6,311,072, issued Oct. 30, 2001 and incorporated herein by reference, discloses an apparatus for translating between telephone signaling protocols. However, this system, assigned to Lucent Technologies, appears to be designed more for interfacing complete telephone systems together, rather than interfacing between two devices on the same phone system.

Thus, the apparatus of Barclay is a fairly complex device (e.g., using Sun Sparc workstations) designed for a specific type of interface between two phone systems. In contrast, in the Alarm industry, there is a need to interface existing alarm systems of many different types to a receiver system at a very low installed cost. A complex interface network such as in Barclay (assuming arguendo such a system would even be applicable) would be too specialized and costly

Wulforst et al. U.S. Pat. No. 6,272,212, issued Aug. 7, 2001, and incorporated herein by reference, discloses a telephone intercept apparatus. The apparatus monitors outgoing telephones numbers and disconnects the telecommunications equipment from the telephone company network and redirects the call to a different number.

Such redialers may redirect a call to a different telephone number. While such a device may have utility, additional data may need to be translated in order for an alarm system to be successfully redirected to a new alarm monitoring company. Moreover, such a redialer needs to monitor for specific DTMF dialing string and then intercept the call before it is completed to the old alarm company. A fairly sophisticated system is required to accomplish this task. In addition, the numbers to be intercepted need to be programmed into the system, either as a database, or through a “learning” mode.

Third party alarm monitoring companies may be interested in obtaining customers (“conversions”) provided by other alarm companies. However, such third party alarm monitoring companies may not be interested in investing in the technology and hardware necessary to translate data from other types of alarm systems to conform with their own equipment. Moreover, customer account numbers and other data from converted customers may conflict or duplicate data from exiting customers.

In addition, alarm monitoring companies may wish to implement additional extra-cost services to enhance revenue streams and provide additional alarm utility for clients. However again, such alarm monitoring companies may not wish to invest in the equipment necessary for such additional services. Moreover, third parties may wish to offer these services without forcing the customer to change alarm monitoring companies.

It may be possible to provide such hardware as a call-intercept device in the customer's home. However, with each additional data conversion or additional service, the complexity of such a home telephone intercept device increases. In order to keep costs down, the nature of a telephone intercept device may need to be kept simple.

In addition, many alarm systems are designed to “seize” the main telephone line when an alarm condition exists. An alarm system is of no use if it cannot dial out. If the system cannot “seize” the line, then a burglar could defeat any alarm system simply by taking an extension phone off the hook after entering the house. Moreover, if a fire or other emergency occurs, the alarm system would have no way of communicating if the homeowner or other occupant was on the phone at the time.

Most alarm systems, and in particular home alarm systems solve this problem by routing the phone line through the alarm system. When an alarm condition occurs, the alarm system disconnects the home phone extensions from the phone line and connects itself to the external phone line and dials out, effectively “seizing” the line.

As noted above, an alarm company may retrofit a redialer or other redirection device in a “conquest” sale from another alarm company. Such a redialer or other redirection device may be placed between the alarm system and the phone line such that any call from the alarm system will go through the redialer or other redirection device and thus be re-routed to the new alarm company. Unfortunately, this means that all calls made from the home (or business) may pass through the redialer or other redirection device.

In the Prior Art, redialers monitored the touch tone number dialed (Dual Tone, Multiple Frequency, or DTMF) and determined whether the number dialed was for the old alarm company. If so, the redial would then intercept the DTMF signal and send out a new DTMF signal to dial the new alarm company. Unfortunately, this meant that the redialer or other redirection device would need monitor the dialing of all calls, potentially delaying phone calls and causing telephone service degradation. Such telephone service degradation is not acceptable to consumers.

As noted above, the DTMF string that is to be checked for must be programmed into the redial, and thus either must be pre-stored in a database or must be “learned” by triggering the alarm and allowing the redialer to capture the DTMF code. Such a “learning” technique may require that a skilled or semi-skilled technician be used to install the device. The device cannot simply be mailed to the homeowner and installed by an amateur.

In addition, it is possible that if a consumer entered the same DTMF number as was programmed for the old alarm company, for example, when using a multi-level voice-mail menu, the redialer or other redirection device may interpret this as a call to the old alarm company and try to insert its own DTMF numbers in place of the consumer's input. Again, such interference is not acceptable to the consumer.

One way to avoid this problem is to rewire the alarm so that it does not “seize” an outside line. However, such a solution defeats one of the security features of the alarm system.

Thus, a need exists in the art for an apparatus and system which can detect the difference between an alarm system outgoing call and a consumer phone call and intercept and redirect only those calls from the alarm system.

### SUMMARY OF THE INVENTION

The present invention solves the aforementioned problems by providing a current detection circuit which is connected in series with the TIP1 and RING1 lines of the alarm panel to detect when consumer provided equipment (CPE) is off-hook. When the alarm system goes off-hook, no current draw will be detected. The apparatus can thus distinguish the difference when a consumer device (phone, fax, modem) goes off-hook and when the alarm panel goes off-hook, and that determine when the alarm panel is trying to dial out.

The apparatus may then redirect the alarm panel call to a different alarm company or other device. By using current draw to distinguish between when the user and the alarm is dialing out, the apparatus need not monitor all outgoing calls for a particular DTMF string. Moreover, if the current draw is used solely as a means of detecting alarm system outgoing calls, the service technician need not program in the DTMF string to search for. Installation is thus simplified and even a homeowner or consumer may install the device.

The system may also check DTMF dialing from the alarm panel to insure the signal being diverted is indeed from the panel and not from a low current draw consumer device (e.g., modem or like). In such an embodiment, the DTMF check is performed only if an alarm panel call is suspected, as determined by the current draw check. Thus, calls made by consumer provided equipment (CPE) need not be checked or delayed unnecessarily.

### BRIEF DESCRIPTION OF THE DRAWINGS

FIG. 1 is a block diagram of a first embodiment of the present invention.

FIG. 2 is another block diagram illustrating the present invention in more detail.

FIG. 3 is a wiring diagram for an RJ31X alarm panel jack.

FIG. 4 is a block diagram of the Panel Saver™ CPE Detection Apparatus of the present invention.

FIG. 5 is a block diagram of an alternative embodiment of the Panel Saver™ CPE Detection Apparatus of the present invention.

### DETAILED DESCRIPTION OF THE INVENTION

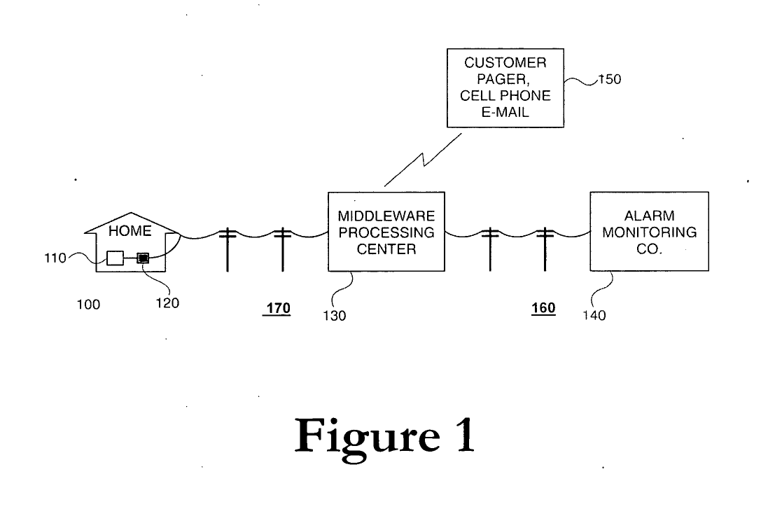

Referring now to FIG. 1, a home 100 is illustrated provided with an alarm system 110. For the purposes of illustration, home 100 is illustrated as a residence. However, home 100 may represent any alarmed structure or device, including but not limited to, businesses, factories, stores, and the like, as well as boats, cars, airplanes, and the like.

Alarm system 110 may comprise any one of a number of known alarm systems used in the art or contemplated in the future. Such alarm systems are characterized in that they usually comprise at lease one sensor device (door or window switch, motion detector, glass break sensor, fire sensor,or the like), a control panel usually including a microprocessor, and a communications device for dialing out to an alarm monitoring station to report alarms as well as device status, activation, and the like.

Telephone redialer 120 may be coupled to alarm system 110. Telephone redialer 120 may intercepts calls from alarm system 110 and redirects such calls to middleware processing center 130 via communication link 170 (e.g., telephone, radiotelephone, cell, or digital cell communication).

One unique feature of redialer 120 is that it first dials a “*82” (or other appropriate code) to unblock caller ID blocking, if such blocking has been enabled by the customer. Note that if the system 110 can be reprogrammed to call the middleware processor, or if the alarm system is initially programmed to call the middleware processor, then telephone redialer 120 may not be required.

Note also, that although disclosed in the environment of using telephone lines 170 to communicate between the alarm system 110, middleware processor 130, and alarm monitoring company 140, other types of communication may be used are all within the spirit and scope of the present invention.

For example, if a home is connected to a DSL (ADSL), cable modem, or other type of Internet connection, the alarm system 110 may generate and transmit an alarm signal over such a network via an e-mail or instant messenger (IM) signal or the like, such that middleware processor 130 receives such a signal. In this manner, the alarm system 110 operates more as an “internet appliance” than as a dial-out modem type device. Thus telephone lines 170 illustrated in FIG. 1 should be interpreted as any of the communication means discussed herein.

Similarly, other types of communication means 160 may be used to communicate between middleware processor 130 and alarm company 140. Thus, other types of communications system may be utilized in place of the phone lines 160 illustrated in FIG. 1, including but not limited to, wireless networks, cellular and digital wireless telephony, local area networks (LANs), local computer communications (e.g., RS-232 or the like). Thus, the telephone lines 160 should be interpreted as any of the communication means discussed herein and not be limited to hard-wired telephone lines.

If present, telephone redialer 120 may redial based upon the phone number input to redialer 120, or may simply redirect all outgoing calls from alarm 110 to middleware processing center 130, via communications link 160, depending upon how alarm system 110 is wired to the telephone system. In many applications, a home alarm 110 may be placed in the line between the TELCO system and the customer's handsets. As a result, every call placed by a customer may go through alarm system 110. By recognizing alarm system calls, redialer 120 may recognize which calls should be redirected to middleware processing center 130.

Middleware processing center 130 may comprise a number of modems, alarm signal receivers, or the like for receiving incoming telephone calls, a computer or computers networked together, for processing incoming calls. Middleware processing center identifies the source of an incoming call based upon the customer's caller-ID number. Alarm data is then translated into a format acceptable to alarm monitoring company 140, including a customer account or identification number correlated from the customer's caller-ID number, and transmitted to alarm monitoring company 140.

The APPENDIX of Provisional U.S. Patent Application Ser. No. 60/389,960 filed on Jun. 20, 2002, contains source code for the working prototype of middleware system 130 in the best mode contemplated at the time of filing of that application. Such software, running on a standard computer system, will redirect alarm calls and attach identification information based upon caller-ID data in the manner set forth in the present invention. In addition, the APPENDIX of U.S. patent application Ser. No. 10/462,708 filed on Jun. 17, 2003 contains additional source code which describes how a signal transmitter may send the alarm signal over a local RS-232 interface to an alarm monitoring station's computers.

Note that for the purposes of this application, “alarm data” include not only signals indicating an alarm, but also information which may be sent by an alarm system, including but not limited to activation and deactivation events, regular system status checks, system status alarms (low battery, tamper) and the like.

To alarm monitoring company 140, it appears only that a typical alarm signal has been received. Alarm monitoring company 140 may then process the signal according to its own internal policies (e.g, dispatching fire or police services, calling the customer, or the like).

In this maimer, a customer at home 100 may subscribe to a different alarm monitoring more than the one, for example, that originally installed the alarm, without having to install more than redialer or reprogramming the alarm system to dial the middleware provider. Once connection to the middleware provider, the subscriber can change monitoring companies at will without further reprogramming of the alarm system and/or without having to install a new redialer. Moreover, the middleware provider may be able to shop around for the lowest cost monitoring solutions and switch the customer to an alternate monitoring station at will. Thus, for example, low cost off-shore alarm monitoring personnel may be used in a manner transparent to the customer.

In addition, the present invention, by using a middleware solution, opens up entire new avenue for ancillary alarm services and products. For example, as illustrated in FIG. 1, a signal may be sent to a customer pager, cellphone, e-mail, land-line or the like 150 indicating that an alarm event has occurred. Middleware processing center 130 may be programmed to retransmit only those alarm signals of interest to a customer (fire, burglary, or the like) rather than all signals including status checks.

In addition, middleware processing center 130 can translate such alarm data into English (for other human language) messages which can be readily understood by the user. Middleware processing center may also be programmed to receive responses from the user to terminate the alarm Thus, for example, if a user accidentally sets off his own alarm, he may receive a text or voice message on his 2-way pager or cell-phone (or other electronic device) indicating an alarm has been activated and requesting a reply (e.g., “CANCEL YlN?).

The user may simply hit “N”, possibly followed by an activation code or password, to cancel the alarm. Middleware processing center 130 may then simply squelch the alarm and not forward it to the alarm monitoring company 140.

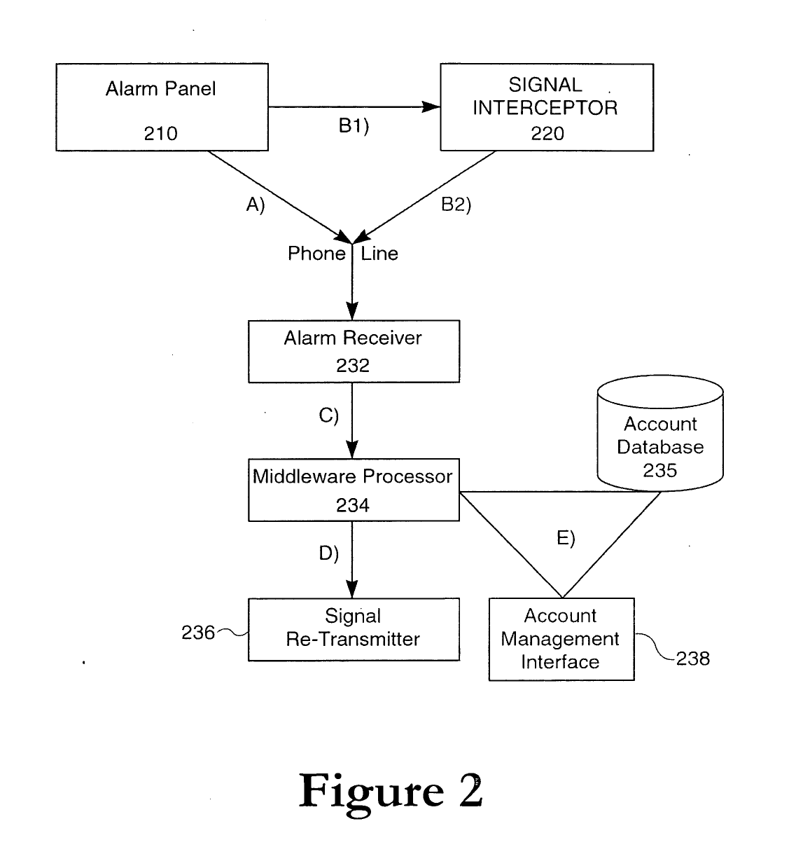

FIG. 2 is another block diagram illustrating the present invention in more detail. Alarm Panel 210 may comprise an off-the-shelf alarm panel installed at the customer premises (home, office, or otherwise) capable of transmitting alarm signals in a standard format to a preprogrammed phone number. Signal Interceptor 220 may comprise a box of the present invention, installed at the customer premises between the control panel and the external phone line. Signal interceptor 220 intercepts outgoing calls, and redirects them to a different phone number (programmed within the box), before connecting the call through to the Alarm Panel.

Alarm Receiver 232 may comprise an off-the-shelf alarm receiver which accepts alarm signals and transmits them to an automation system, including the original signal as well as Caller-ID information. Middleware Processor 234 may comprise a computer system of the present invention which accepts alarm signals from an Alarm Receiver (including Caller-ID information). Upon receiving alarm information, Middleware Processor 234 may look up the account information in a database (using criteria such as Caller-ID information, receiver phone line, or alarm signal account number).

From the information contained in the Account Database 235, Middleware Processor 234 may carry out retransmission instructions contained therein. One possible retransmission instruction might be to dial another central station and retransmit the alarm signal (in its original form, in a translated form such as altering the account number). Other retransmission instructions might include the sending of an E-Mail message, Fax, RPC (Remote Procedure Call), or other alert.

Account Database 235 may comprise a computerized database of the present invention, containing data of alarm accounts, including the phone number to which the Alarm Panel or Signal Interceptor is connected (used for Caller-ID account lookups), and any translation or retransmission instructions winch the Middleware Processor must perform upon receiving a signal.

Signal Re-Transmitter 236 may comprise a computerized alarm signal delivery system of the present invention, which may carry out the instructions of the Middleware Processor when so directed. Alarm signals may be re-transmitted as new alarm signals, in which case the Re-Transmitter dials a phone number and impersonates the original Alarm Panel (possibly with an alter alarm signal message, such as a different account number or different zone information). The Re-transmitter can also transmit an alarm signal using other formats and mediums, such as E-Mail, Fax, or RPC or transmission to a monitoring station's internal automation system using RS 232 Local Area Network (LAN) or the like.

Account Management Interface 238 may comprise a computer program used by account managers to maintain Alarm Account information in the Account Database. Account information

May include the original phone number of the Alarm Panel or Signal Interceptor, as well as additional translation and re-transmission instructions.

While disclosed in the context of alarm system technology, the present invention can be used for other types of autodialer equipment, such as “smart home” monitoring equipment and the like. Thus, a user may be able to centralize a number of autodialer functions to a single middleware provider which can then redirect such data to appropriate destinations.

In another variant, a customer's Alarm Panel may be connected directly to a telephone line, and may be programmed to dial the Alarm Receiver which is connected to the Middleware Processor. In this variant, no Signal Interceptor is required.

In another variant, a customer's Alarm Panel may be connected first to a Signal Interceptor (B1), and then to a telephone line (B2). In this variant, the Alarm Panel may have been programmed to dial the wrong telephone number (e.g., former alarm company), and may be prohibitively expensive or impossible to reprogram. Thus, the Signal Interceptor will redirect the telephone call to the correct Alarm Receiver, to be handled by a Middleware Processor.

In another variant, the Alarm Receiver may be incapable of decoding Caller-ID information, and transmits only the original alarm signal information to the Middleware Processor. In this variant, the Middleware Processor is able to perform account lookups using alarm receiver phone line identifiers, and alarm signal account numbers.

In another variant, the Alarm Receiver may decode Caller-ID information and transmits this information, along with the original alarm signal, to the Middleware Processor. In this variant, the Middleware Processor is able to perform account lookups using Caller-ID information as well as alarm receiver phone line identifiers and alarm signal account numbers.

In another variant, the Middleware Processor may instruct the Signal Re-Transmitter to dial another alarm Receiver (such as one located at an Alarm Monitoring Station) and impersonate the original Alarm Panel, sending the original alarm signal.

In another variant, the Middleware Processor may instruct the Signal Re-Transmitter to dial another Alarm Receiver (such as one located at an Alarm Monitoring Station), and impersonate the original Alarm Panel, sending an alarm signal with a translated message. This message might have the number, zones, or other signal information altered from its original contents, as specified by the translation instructions contained within the Account Database.

In another variant, the Middleware Processor may instruct the Signal Re-Transmitter to dial two or more other Alarm Receivers and transmit the alarm signal, in original or in translated form, as detailed in variants listed above.

In another variant, the Middleware Processor may instruct the Signal Re-Transmitter to sent an electronic mail (E-Mail) message containing the alarm signal information to an E-Mail address specified in the Account Database.

In another variant, the Middleware Processor may instruct the Signal Re-Transmitter to send electronic Fax document containing the alarm signal information to a Fax phone number specified in the Account Database.

In another variant, the Middleware Processor may instruct the Signal Re-Transmitter to sent an electronic page containing the alarm signal information to a pager phone number or address specified in the Account Database.

In another variant, the Middleware Processor may instruct the Signal Re-Transmitter to send a voice message containing the alarm signal information to a phone number specified in the Account Database.

In another variant, the Middleware Processor may instruct the Signal Re-Transmitter to send a Remote Procedure Call (RPC) to another computer. A Remote Procedure Call is a computer to computer message indicating some event has occurred, or some action should be taken. The network across which communication takes place can be an internal network (LAN) within a company, or it can be across the public Internet. The format of the message is typically one of several popular RPC formats, including: SOAP, XML-RPC, Java RMI, DCOM, or CORBA. The present invention is capable of accepting an Alarm Signal, generating an RPC message, and transmitting the message to another computer address, using an RPC format and destination computer address specified in the Account Database.

In another variant, the Middleware Processor may instruct the Signal Re-Transmitter to sent a Remote Procedure Call (RPC) to another computer on the local network, or on the Internet.

In another variant, the Account Management Interface may allow the administrative staff of the System to manage account information for all of it's customers using a graphical (GUI) or browser-based interface.

In another variant, the Account Management interface may allow alarm system dealers to manage account information for their own accounts using a graphical (GUI) or browser-based interface. In this variant, the Account Database stores information about each dealer as well as each individual customer account, including which customer accounts belong to which dealers. Dealers are only allowed to administer the customer accounts which belong to them, and can specify phone number information, translation instructions, and re-transmission instructions for each account.

In another variant, the Account Management Interface may allow individual customers to manage their own account, including phone number information, translation instructions, and retransmission instructions.

In another variant, the middleware processor may not retransmit the alarm signal at all, but may simply record it in a account database, for later reporting and reviewing by the alarm company, or by the customer. In this embodiment, the middleware processor may be viewed as the endware. Such an embodiment may be useful where a user wishes to log access to a building or computer system or the like.

In another variant of the present invention, the middleware processor may be programmed to receive alarm signals in the form of a Remote Procedure Call (RPC) rather than in the form of a telephone-transmitted alarm panel signal. In this embodiment, the middleware processor may accept the RPC message from a remote computer and process it as if it were an original panel signal and send it to the signal re-transmitter in the same way as the other variants.

Thus, for example, a computer system or network may generate alarm signals for transmission as RPC messages over a computer network or the like. Such alarm messages may indicate the activation of an alarm system coupled to the network or computer, or may indicate an unauthorized user is attempting to access the computer or network. Thus, a computer system or network can be monitored remotely even when no one is physically present at the location of the computer or network.

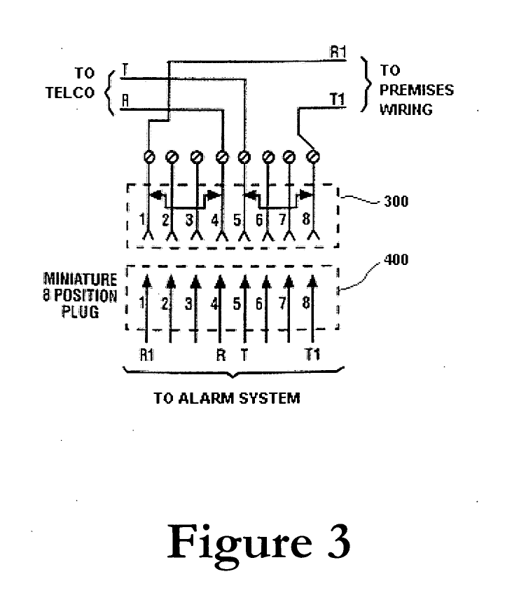

FIG. 3 is a wiring diagram for an RJ31X alarm panel jack. Prior to discussing the Panel Saver™ apparatus of the present invention, a review of alarm panel wiring may be in order. Note that for the purposes of this application, the term “jack” will be construed to mean a female receptacle or outlet for accepting a male “plug”. The term “plug” will refer to the male connector which is accepted by the female “jack”.

Today, the presence of multiple phone lines in the home may be taken for granted, but it wasn't long ago that using the phone lines for monitoring was simply out of the question and deemed not reliable enough. When an alarm went off, it would have to dial up (via pulse switching) to the central station and report the alarm. There were just too many times that a call counld not be completed, and that would result in an alarm not being reported. But stringing copper is expensive, and phones have gotten more reliable. The tremendous growth of security systems in residences has forced homeowners to use the regular phone systems for monitoring.

This actually works pretty well except for one thing: People naturally didn't want to put in an extra phone line for the security system, they wanted the new system to use their existing phone line. However, this presents a problem if the phone is off the hook when the alarm goes off. Or, as noted above, if a burglar knows about this, he may simply pick up any phone in the house and interferes with the automated call in some manner.

The solution to these problems is to connect the alarm system ahead of all the phones in the house and build in a relay so it can disconnect house-phones and do its thing. Even if there is a call in progress, it can “seize” the line, hang-up, and dial the monitoring company. There's only one minor “interfacing” problem with this approach, which seems almost trivial, but it ended up requiring a unique piece of equipment to solve.

In practice, the person installing phone wiring, and the person installing the security system, are usually two different people and usually two different companies. Oftentimes, the two companies could never agree on where the interconnection between the two systems should be, how it should hook up, and the like. And when anything went wrong, the two companies would just point fingers at each other.

When the phone installer finished, the phones still wouldn't work because the security system wasn't installed so that its relay could short the inside wiring to the CO (company office) line. If there ever was a problem, there was no easy way to tell if it was the security system's fault. Or, worse yet, if the security system failed, it would take down all the inside phones.

Fortunately, this problem had a very simple solution. A jack was designed, the RJ31X, which could be inserted in the line between the CO and all the house phones. When nothing is plugged into the jack, the house-phones are simply connected to the CO line via “shorting bars”. But when the security system is plugged into the jack, it is “inserted” into the loop and has separate connections to the inside phones and the CO line.

So the telephone installer is simply told to “put an RJ31X jack here” and he is supposed to know what that means. Even though the security system isn't plugged in yet, the phones will still work, properly and the phone line installer can complete his task without having to wait for the alarm installer to visit. Similarly, the alarm installer need not cut into existing phone wires in order to install the alarm system. The alarm system can be plugged into the RJ31X jack. The RJ31X jack 300, as we shall see, also provides a connection point for the Panel Saver™ apparatus of the present invention.

When the security installer has the security panel up and ready, he plugs the panel RJ31X plug 400 into RJ31X jack 300 and the installation is complete—without having to alter or disturb existing phone wiring. If there's ever any question about whether the panel is interfering with the phone lines, or if the panel fails, the homeowner can quickly unplug the panel from the jack.

As illustrated in FIG. 3, up to four tip and ring circuits (lines) may be supported by the RJ31X jack 300 through pins 1-8. Series tip and ring connections and sometimes auxiliary leads such as A and A1 provide seizure or exclusion service delivering dial tone to a particular device while excluding, or electrically disconnecting other devices.

The RJ31X jack comprises an eight-position, non keyed miniature jack assembly equipped with shorting bar returns circuits to bridge service when the mating eight-position modular plug is removed. To assure seizure when required, the phone line is wired in series through the RJ31X as follows (a single-line installation is used as an example). Telco phone line wires Ring R and Tip T are wired to pins 4 and 5 of the RJ31X jack, respectively, as illustrated in FIG. 3. The premises (e.g., house or business or the like) phone line wires Tip T1 and Ring R1 attached to consumer provided equipment (CPE) are wired to terminals 8 and 1, respectively, of the RJ31X jack as illustrated in FIG. 3.

If no RJ31X plug is inserted into the RJ31X outlet, shorting bars short pins 1 and 4 together and also short pins 5 and 8 together. Any network interface jack which may allow a connected device to disrupt basic telephone service to other devices because of its wiring configuration (for example, by running tip and ring through a relay) must have a provision to automatically return service to the other locations if the seized device (the alarm unit) malfunctions. In the RJ31X jack, this is accomplished with shorting bars. Gold-plated metal tabs inside the RJ31X device will provide direct connection of tip and ringback to the other locations (bypassing the alarm device) when the miniature eight-position plug is remove from the jack. In this manner, the “house” phone line wires Tip T and Ring R are connected directly to telco line wires Tip T1 and Ring R1 respectively. Inserting the plug lifts the gold plated contact wires away from the shorting bars. and extends the tip and ring circuit to the series leads going into the alarm device.

If an RJ31X plug is inserted into the RJ31X outlet, the Tip T and Ring R pass into the alarm equipment where a relay decides whether the dial tone will go back out to the “house” line wires Tip T1 and Ring R1, or be seized for use by the alarm. In the present invention, the Panel Saver™ apparatus may be provided with an RJ31X compatible male plug and an RJ31X compatible female outlet. In use, the installer (or consumer) merely unplugs the RJ31X plug connected to the alarm panel from the RJ31X jack and inserts the present invention in series. Thus, the consumer can use the services of a new alarm company without having to throw away the old alarm panel, hence the trademark Panel Saver™. Panel Saver™ is a trademark of NextAlarm, Inc.

As noted above the connections for the present invention may be provided as RJ31X compatible plugs and jacks. This means, for example, that the form factor of the plugs and jacks may be similar to that of a standard RJ31X plugs and jacks. However, the functionality of the shorting bars may be eliminated to reduce cost. As the device of the present invention is designed to be placed between the RJ31X jack and the alarm panel plug, it may not require the shorting bar feature of a standard RJ31X outlet.

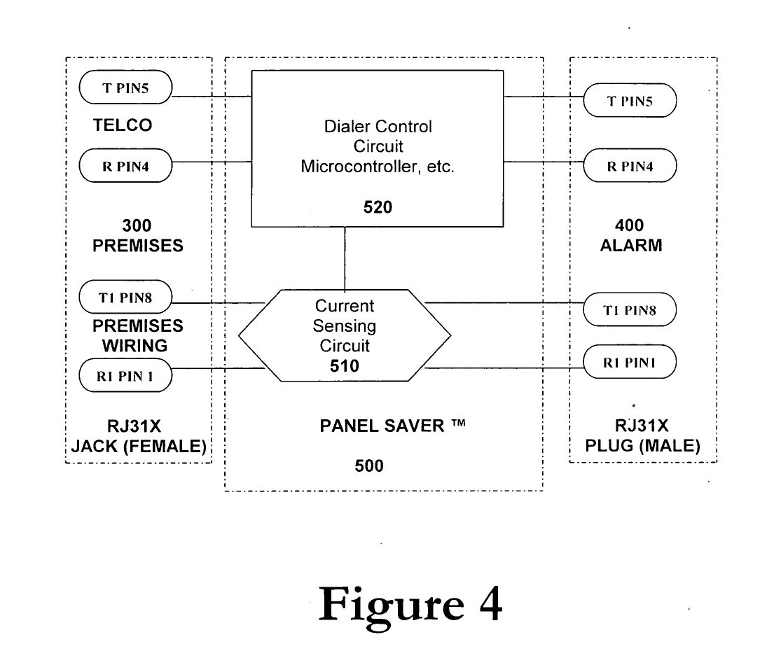

FIG. 4 is a block diagram of the Panel Saver™ CPE Detection Apparatus of the present invention. FIG. 4 comprises three main elements; RJ31X jack 300, RJ31X plug 400 and Panel Saver™ device 500. For the purposes of illustration, the corresponding jacks and plugs on the Panel Saver™ device are not shown as separate elements. However as is readily apparent, the Panel Saver™ device of the present invention plugs into jack 300 and accepts plug 400 as illustrated schematically in FIG. 4. Also for the purposes of illustration, only pins 1, 4, 5, and 8 of the RJ31X jack and plug are illustrated as these are the pins used for a single-line installation.

Jack 300 comprises a standard RJ31X female receptacle wired as noted above using standard convention. In most applications, this jack 300 is wired by the phone company but may be wired by the alarm company or other installer. For the installer of the Panel Saver™ the jack should already be present on the premises (e.g., home, office, or other location) where the Panel Saver™ is to be installed. Pins 4 and 5, as noted above in connection with FIG. 3, are connected to the telco wiring as wires Ring R and Tip T, respectively. Pins 1 and 8 are wired conventionally to the consumer provided equipment (CPE) as wired Ring R1 and Tip T1, respectively. In this manner, jack 300 is wired as a conventional alarm jack and is not disturbed by the installer of the Panel Saver™.

Similarly plug 400 represents an RJ31X plug connected to a wire lead that is connected to an existing alarm panel (not shown). Again, plug 400 is conventionally wired as illustrated in FIG. 3. Pins 4 and 5 of plug 400 are phone line output lines which ordinarily would connect to Ring R and Tip T of the telco wiring, when plug 400 is inserted into jack 300. Pins 1 and 8 are phone input lines which ordinarily would connect to Ring R1 and Tip T1 of the premises wiring when plug 400 is inserted into jack 300. Thus, when plug 400 is plugged directly into jack 300, all premises phone signals (CPE) pass through the alarm system (not shown) and back out to the telco.

When Panel Saver™ 500 is connected in series with plug 400 and jack 300, phone calls made by consumer provided equipment (CPE) are routed through Panel Saver™ 500 before they reach the alarm system and output from the alarm system is similarly routed through Panel Saver™ 500. Outgoing alarm calls from the alarm system (not shown) are redirected and/or recorded as described above by dialer control circuit and microcontroller 520. Dialer control circuit and microcontroller 520 detects when an alarm call is being made and redirects that call using DTMF dialing or other means to divert the alarm call to a new or different alarm monitoring company or to another device, middleware processor or the like as discussed above.

As noted above, many Prior Art redialers relied upon DTMF detection in order to distinguish an alarm signal from ordinary dialouts from CPE. In the present invention a Current sensing circuit 510 is provided in series between pins 1 and 8 of jack 300 and pins 1 and 8 of plug 400. When consumer provided equipment on the “house” lines tries to dial out on pins 1 and 8, current sensing circuit 510 measures the current draw on the lines. However, when the alarm system tries to dial out over pins 4 and 5, current sensing, circuit 510 measures no current, as the signal does not pass through pins 1 and 8.

Thus dialer control circuit and microprocessor controller 520 may readily distinguish between calls from the alarm system (not shown) and calls from consumer provided equipment. If the calls are from the alarm system, dialer control circuit and microprocessor 520 may suitably redirect such calls and recode them if necessary.

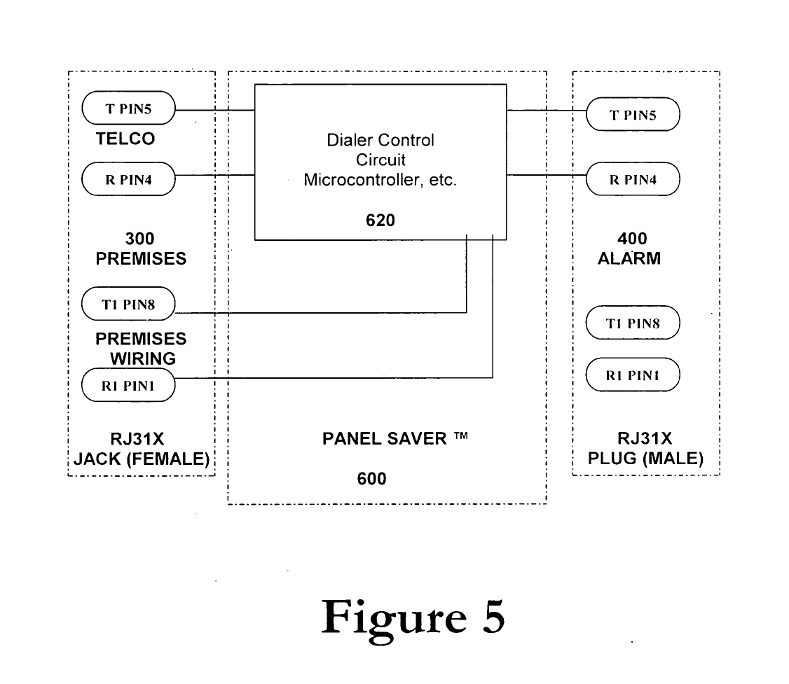

FIG. 5 is a block diagram of an alternative embodiment of the Panel Saver™ CPE Detection Apparatus of the present invention. This embodiment is similar that set forth in FIG. 4, except that signals from CPE (consumer provided equipment) are routed within Panel Saver™ 600 back to the telco lines via pins 4 and 5. In this embodiment, the line seizure feature of the host alarm system is bypassed entirely. Panel Saver 500™ directs all calls placed by the consumer on CPE directly to the telco under ordinary circumstances. When a call is placed by the alarm system (not shown) indicated by an incoming call on pins 4 and 5 of plug 400, Dialer Control Circuit 620 of Panel Saver™ 600 seizes the line on pins 4 and 5 of jack 300 and dials out according to its pre-programmed plan. Panel Saver™ 600 may thus redirect and reprogram alarm calls while insuring that consumer calls are not disturbed.

While the preferred embodiment and various alternative embodiments of the invention have been disclosed and described in detail herein, it may be apparent to those skilled in the art that various changes in form and detail may be made therein without departing from the spirit and scope thereof.

1. An apparatus for redirecting alarm calls, comprising:
first means for connecting to an alarm system to receive alarm system calls;
second means, for connecting to telephone equipment for receiving telephone equipment call;
third means, coupled to the first means, for connecting to a telephone system for selectively sending alarm system calls and telephone equipment calls; and
monitoring means, for determining whether a call made on the telephone system is an alarm call or a telephone equipment call, and selectively redirecting a call if it is determined to be an alarm call.

2. The apparatus of claim 1, wherein the first means for connecting to an alarm system comprises a portion of an RJ31X jack for connecting to a corresponding portion of an RJ31X plug from an alarm system for receiving outgoing telephone signals from the alarm system, the outgoing telephone signals including alarm system calls and telephone equipment calls routed through the alarm system.

3. The apparatus of claim 2, wherein the second means for connecting to telephone equipment includes a portion of an RJ31X plug for connecting to a corresponding portion of an RJ31X jack of telephone equipment for receiving telephone equipment calls, the telephone calls being routed through the alarm system.

4. The apparatus of claim 3, wherein the third means for connecting to a telephone system comprises another portion of the RJ31X plug, for connecting to a telephone system for outputting the outgoing telephone signals from the alarm system and the telephone equipment calls to the telephone system.

5. The apparatus of claim 4, further comprising a fourth means, coupled to the second means, for connecting the telephone equipment to the alarm system such that telephone equipment calls are routed through the alarm system.

6. The apparatus of claim 5, wherein the monitoring means monitors current passing from the second means to the fourth means and determine a call made on the telephone system is a telephone equipment call if current is passing from the second means to the fourth means.

7. The apparatus of claim 1, wherein the second means is coupled to the monitoring means, and whereby telephone equipment calls are routed through the monitoring means, bypassing the alarm, and wherein said monitoring means seizes the second means coupled to the telephone system if an alarm system call is detected and sends a redirected alarm system call through the telephone system.

8. An apparatus for redirecting telephone calls, comprising:
first means for connecting to a first device for receiving calls from the first device;
second means, for connecting to a second device for receiving calls from the second device;
third means, coupled to the first means, for connecting to a telephone system for selectively sending calls from the first device and the second device; and
monitoring ring means, for determining whether a call made on the telephone system is from the first device or the second device, and selectively redirecting a call if it is determined to be from the first device.

9. The apparatus of claim 8, wherein the first means for connecting to a first device comprises a portion of a communications jack for connecting to a corresponding portion of a communications plug from the first device for receiving outgoing telephone signals from the first device, the outgoing telephone signals including calls from the first device and calls from the second device routed through the first device.

10. The apparatus of claim 9, wherein the second means for connecting to a second device includes a portion of a communications plug for connecting to a corresponding portion of a communications jack of a second device for receiving calls from the second device, the calls from the second device being routed through the first device.

11. The apparatus of claim 10, wherein the third means for connecting to a telephone system comprises another portion of the communications plug, for connecting to a telephone system for outputting outgoing calls from the first device and calls from the second device to the telephone system.

12. The apparatus of claim 11, further comprising a fourth means, coupled to the second means, for connecting the second device to the first device such that second device calls are routed through the first device.

13. The apparatus of claim 12, wherein the monitoring means monitors current passing from the second means to the fourth means and determines a call made on the telephone system is a second device call if current is passing from the second means to the fourth means.

14. The apparatus of claim 8, wherein the second means is coupled to the monitoring means, and whereby second device calls are routed through the monitoring means, bypassing the first device, and wherein said monitoring means seizes the second means coupled to the telephone system if a first device call is detected and sends a redirected first device call through the telephone system.

15. A plug-in module for redirecting alarm system telephone calls, said module comprising:
a female RJ31X jack, connectable to a male RJ31X plug on an alarm system, the female RJ31X jack having pins 4 and 5 wired to a telco and pins 1 and 8 wired to premises wiring, wherein pins 4 and 5 are connectable to the alarm system for receiving( calls from the alarm system when a RJ31X plug from an alarm system is plugged into the female RJ31X jack;
a male RJ31X plug, connectable to a female RJ3 X jack in telephone network, the male RJ31X plug being wired to the alarm system so that pins 4 and 5 receiving outgoing calls from the alarm system, wherein pins 4 and 5 are connectable to a telephone company line when the male RJ31X plug is plugged into the female RJ31X jack; and
monitoring means, coupled to the female RJ31X jack and the male RJ31X plug, for determining whether a call made on the telephone company line is from the alarm system or the consumer provided equipment, and selectively redirecting a call if it is determined to be from the alarm system.

16. The plug-in module of claim 15, wherein the male RJ31X plug has pins 1 and 8 connectable to the alarm system, for connecting the consumer provided equipment to the alarm system such that consumer provided equipment calls are routed through the alarm system.

17. The plug-in module of claim 16, wherein the monitoring means monitors current passing from the consumer provided equipment to the alarm system and determines a call made on the telephone company line is a consumer provided equipment call if current is passing from the consumer provided equipment to the alarm system.

18. The plug-in module of claim 17, wherein pins 1 and 8 of the female RJ3 X jack are routed to the monitoring means, and whereby consumer provided equipment calls are routed through the monitoring means, bypassing the alarm system, and wherein said monitoring means seizes the telephone company line if a alarm system call is detected and sends a redirected alarm system call through the telephone company line.
